(19) United States
(12) Patent Application Publication
(10) Pub. No.: US 2002/0092382 A1
(43) Pub. Date: Jul. 18, 2002

(54) One piece speed wrench

(76) Inventors: Michael J. Lehman, Fort Wayne, IN (US); Paul R. LaVelle, Springfield, OH (US); Robert C. Thomas, Springfield, OH (US)

Correspondence Address: INTERNATIONAL TRUCK, INTELLECTUAL PROPERTY COMPANY, LLC., 4201 WINFIELD ROAD, P.O. BOX 1488, WARRENVILLE, IL, 60555, US

(21) Appl. No.: 10/038,020

(22) Filed: Jan. 3, 2002

Related U.S. Application Data
(60) Provisional application No. 60/259,937, filed on Jan. 5, 2001.

(51) Int. Cl. B25B 13/02

(52) U.S. Cl. 81/119

(57) ABSTRACT

A one-piece speed wrench has a handle and two engagement prongs joined at an engagement area. One prong, the in-line prong, may be parallel with the length of the handle. The other prong, an offset angle prong, contains at least one notch. The notch has two faces. When viewed from the side, one face, the inboard face closest to the engagement area between the two prongs, is at an angle with the face of the in-line prong. The inboard face of each notch is in a preferred embodiment approximately a third as long as each face of the hexagonal fastener. The outboard face adjacent to the inboard face of each notch is at a decreasing angle with the in-line prong in the direction away from the prong engagement area. This decreasing angle of the outboard face of each notch allows for a ratcheting effect. There may be more than one notch, with each notch corresponding to a different size hexagonal fastener. The tool of this invention offers the function of an expensive ratchet type tool and will fit multiple size fastener heads. This tool has no moving parts but still allows a ratcheting effect when used on fasteners.

This non-provisional patent application claims priority under Provisional Patent Application Serial No. 60/259,937, filed Jan. 5, 2001.

### BACKGROUND

This invention relates to tools for tightening fasteners, particularly hexagonal shaped fasteners such as nuts or bolt heads or instruments engaged with hexagonal fasteners. Specifically, the tool of this invention offers the function of an expensive ratchet type tool and will fit multiple size fastener heads. This tool has no moving parts but still allows a ratcheting effect when used on fasteners.

### PRIOR ART

Ratchet wrenches are used to tighten fasteners without having to be removed from the fastener and repositioned after partial force applied rotations of the fasteners. These ratchets involve moving parts that allow the handle to be free swung back for additional force applied rotations of the fasteners.

Additionally, there have been wrenches with no moving parts that engage two opposing parallel sides of hexagonal fasteners. One of these is shown as the invention of U.S. Pat. No. 6,009,778. Additionally, there have been wrenches that engage adjacent faces of hexagonal fasteners. Two such wrenches are shown in U.S. Pat. Nos. 3,858,464 and 4,167,882. Neither of wrenches that have prong faces for engaging faces other than opposing faces allowing for a ratcheting effect. In other words, a user of either of these wrenches is required to completely remove the wrench from the fastener and reposition it to another set of faces. This is because the prong inner faces directly mate up with complete faces of the fastener. Additionally, the engagement of adjacent faces keeps the prongs mated against the faces during force-applied rotation.

What is needed is a wrench that may engage a hexagonal fastener on faces that are not immediately adjacent and not opposing and allows a ratcheting effect when used on a hexagonal fastener.

### SUMMARY

An objective of the invention is to provide a wrench that may engage a hexagonal fastener on faces that are not immediately adjacent and not opposing and allows a ratcheting effect when used on a hexagonal fastener.

The one-piece speed wrench of this invention satisfies the objective of this invention. The one-piece speed wrench has a handle and two engagement prongs joined at an engagement area. One prong, the in-line prong, may be parallel with the length of the handle. The other prong, an offset angle prong, contains at least one notch. The notch has two faces. When viewed from the side, one face, an inboard face closest to the engagement area between the two prongs, is at an angle with the face of the in-line prong. The inboard face of each notch is in a preferred embodiment approximately a third as long as each face of the hexagonal fastener. The outboard face adjacent to the inboard face of each notch is at a decreasing angle with the in-line prong in the direction away from the prong engagement area. This decreasing angle of the outboard face of each notch allows for a ratcheting effect. There may be more than one notch, with each notch corresponding to a different size hexagonal fastener.

### DRAWINGS

Other objects and advantages of the invention will become more apparent upon perusal of the detailed description thereof and upon inspection of the drawings, in which:

FIG. 1 is a side view of a one-piece speed wrench made in accordance with this invention.

FIG. 2 is a bottom up view of the wrench of FIG. 1.

FIG. 3 is an exploded view of the circled portion of FIG. 1.

FIG. 4a is a side view of a one-piece speed wrench made in accordance with this invention along with a fastener in a first of a sequence of operation steps.

FIG. 4b is the wrench of is a side view of a one-piece speed wrench made in accordance with this invention along with a fastener in a second of a sequence of operation steps.

FIG. 4c is the wrench of is a side view of a one-piece speed wrench made in accordance with this invention along with a fastener in a third of a sequence of operation steps.

FIG. 5 is an exploded view of the circled portion of FIG. 4c.

### DETAILS OF INVENTION

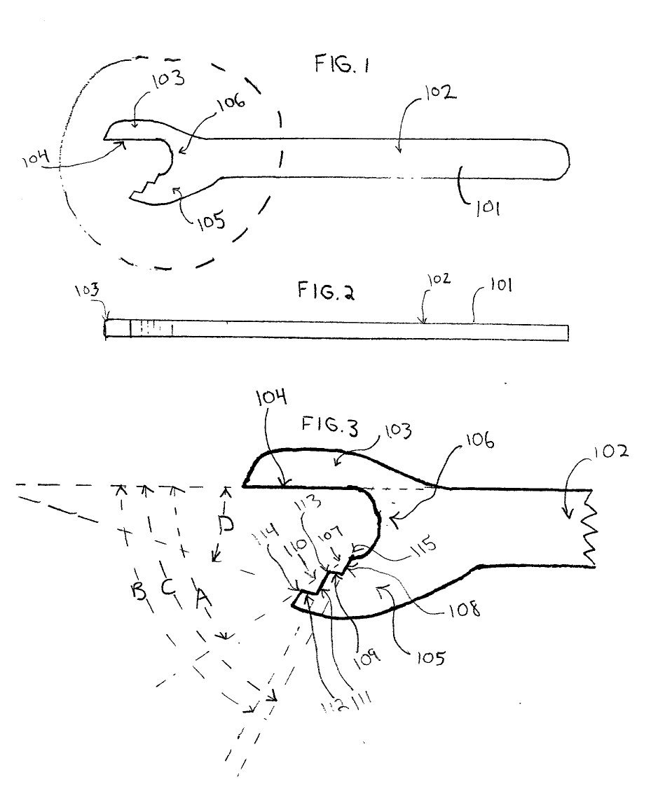

A one-piece speed wrench 101 shown in FIGS. 1 to 5 is made in accordance with this invention. The wrench 101 has a handle 102 and two engagement prongs, 103 and 105, joined at an engagement area 106. One prong, the in-line prong 103, may be parallel with the length of the handle 102. The other prong, an offset angle prong 105, contains at least one notch 107. The notch 107 has two faces 108 and 109. There may be a second notch 110 with faces 111 and 112, with face 111. When viewed from the side of notch 107, one face, the inboard face 108 closest to the engagement area 106 between the two prongs, is at an angle C with an engagement face 104 of the in-line prong 103. Angle C approximately corresponds to or is slightly less than the angle between two sides, 161 and 163, of a hexagonal fastener 160 that are one side apart. That is the reference faces of the hexagonal fastener exterior 160 are neither immediately adjacent (as would be faces 161 and 162) nor directly opposing (i.e. in parallel, as would be faces 161 and 164). These faces 161 and 163 are at a 60-degree angle with each other. The face 104 of the in-line prong 103 and the inboard face 108 of the notch 107 of the offset angle prong 105 are at angle C with each other, angle C being equal to or preferably slightly less than 60 degrees. Similarly, notch 110 of the offset angle prong 105 has an inboard face 111. The inboard face 111 is at angle B with the face 104 of the in-line prong 103. Angle B is equal to angle C. The inboard faces 108 and 111 of each notch 107 and 110 are less than the length of each face of the fastener 160 to which it is sized to fit. In a preferred embodiment these inboard faces 108 and 111 are approximately a third as long as each face of the hexagonal fastener 160. The outboard faces 109 and 112 adjacent to the inboard faces 108 and 111 of each notch is at a decreasing angle D with the in-line prong face 104 in the direction away from the prong engagement area 106. An imaginary line drawn from each of outboard faces 109 and 112 will approach an imaginary line drawn from the face 104 of the in-line prong 103. These imaginary lines would meet at the center of angle D. The decreasing refers to the side view FIG. 3. This decreasing angle D of the outboard face of each notch allows for a ratcheting effect. In one embodiment angle D is between 20 and 30 degrees, with a preferred embodiment at approximately 25 degrees.

The engagement area 106 is shown as defining a semi-circular void area. The semicircular shape is one workable embodiment however other shapes are also acceptable provided that the interaction between the face 104 of the in-line prong 103 and the notches are not effected. The face 162 of the hexagonal fastener should not come into contact with the engagement areas or the prongs else the desired interaction between the face 104 and the notches will be impacted.

There may be more than one notch, with each notch corresponding to a different size hexagonal fastener. Where there is more than one notch, a , line through the outer tips 113, 114, and 115 of each notch will be at an angle A that is less than 60 degrees with the engagement face 104 of the in-line prong 103. One embodiment had this angle to be between 30 and 40 degrees with a preferred embodiment at a 34-degree angle.

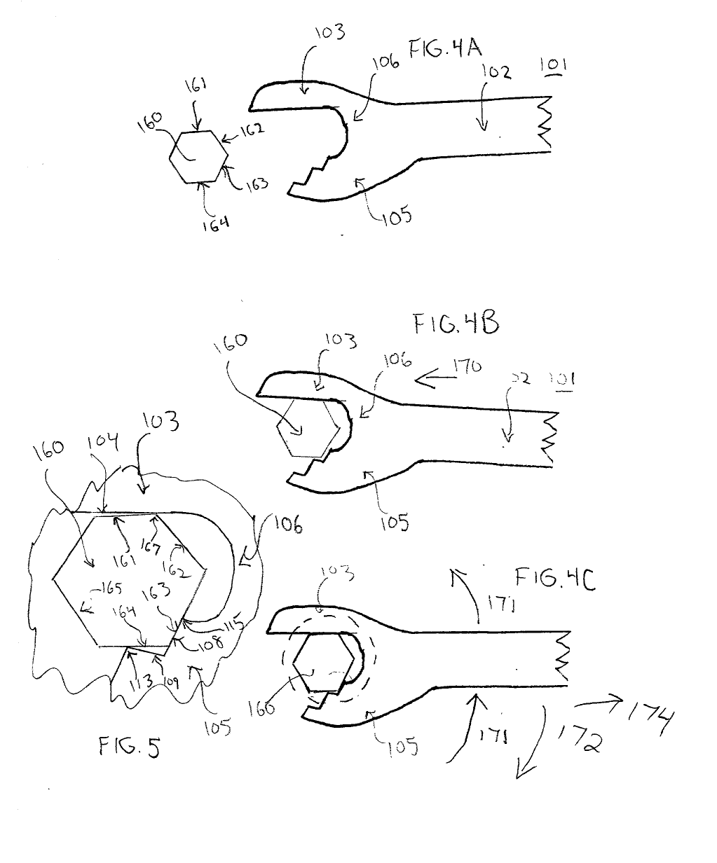

The combination of angle B or C being at or less than 60 degrees and angle D being decreasing in the direction away from the engagement area 106 allows enough play or movement of the fastener 160 upon engagement with the wrench 101 to approximate a ratcheting effect. FIGS. 4a to 4c and FIG. 5 demonstrate how a user of the wrench 101 would ratchet a hexagonal fastener 160 in one rotational direction 171. The wrench 101 is directed into contact with the fastener 160 by moving the wrench to the fastener in direction 170. The face 161 initially comes into full contact with the face 104 of the in-line prong 103. Face 163 comes into contact with outer tip 115 of notch 107. The user of the wrench 101 rotates the handle 102 in direction 171. Inboard face 108 comes into contact flush against face 163 of the fastener that is one face removed from face 161. At the same time, face 161 rotates out of full contact with face 104 of the in-line prong 103 about an edge 167 that lays between faces 161 and 162 of the fastener 160. With force applied to the handle 102 in angular direction 171, the fastener 160 is wedged within the wrench in three areas. These are edge 167 on face 104, face 163 on inboard face 106, and additionally face 164, which is adjacent to face 163, on the outer tip 113 of notch 107. A gap is formed between outboard face 109 of the notch 107 and face 164 of the fastener 160. Upon completion of the initial rotation or ratchet of the fastener 160, the pressure in angular direction 171 is removed. The gap under face 164 allows an easy release of the fastener from firm engagement with the wrench. The user of the wrench moves the handle slightly in direction 174 just until face 163 is clear of outer tip 113 of notch 107. The user simultaneously disengages the face 104 of the in-line prong 103 from face 163 and rotates the handle in reverse angular direction 172 until the face 104 is mated with a new face of the fastener. The process is repeated with the notch 107 and the prongs being acted on different faces of the fastener. The open-ended nature of the prongs and angles of the faces of the notch allow short angular movements of the handle 102 and quick release of the fastener 160 from the prongs and notch 107. The user may use the short strokes to tighten a fastener in a confined or limited space. Applicants have found considerable success using the wrench 101 for tightening instruments with hexagonal fasteners in motor vehicle under hood applications where there are a number of clearance issues.

As described above, the one-piece speed wrench 101 provide a number of advantages, some of which have been described above and others of which are inherent in the invention. Also modifications may be proposed to the wrench 101 without departing from the teachings herein.

We claim:

1. A one-piece speed wrench for engaging and rotating a hexagonal fastener with outward sides of specified lengths and that are at specified angles to each other, comprising:
a handle and two engagement prongs joined at an engagement area;
one of said engagement prongs, an offset angle prong, contains at least one notch, a first notch;
said offset angle prong notch having two faces;
one of said faces of said first notch, an inboard face closest to said engagement area between said two prongs, is at an angle with an engagement face of said second prong when viewed from a side; and
said angle between said inboard face of said first notch and said engagement face of said second prong approximately corresponds to or is slightly less than the specified angles between two outward sides of the hexagonal fastener.

2. The speed wrench of claim 1, wherein:
said offset angle prong has a second notch also having two faces;
one of said faces of said second notch of said offset prong, an inboard face closest to said engagement area between said two prongs, is at an angle with an engagement face of said second prong when viewed from a side;
said angle between said inboard face of said second notch and said engagement face of said second prong approximately corresponds to or is slightly less than the specified angles between two outward sides of the hexagonal fastener.

3. The speed wrench of claim 2, wherein:
said second prong is an in-line prong and is parallel with a length of said handle.

4. The speed wrench of claim 2, wherein:
said inboard faces of said first and second notches having a shorter length than the specified lengths of the outward sides of the hexagonal fastener.

5. The speed wrench of claim 4, wherein:
said inboard face being approximately a third as long as each outward side of the hexagonal fastener.

6. The speed wrench of claim 5, wherein:
each said notch has an outboard face adjacent to said inboard faces; and
said outboard faces being at a decreasing angle with the in-line prong face in a direction away from said prong engagement area.

7. The speed wrench of claim 6, wherein:
said decreasing angle of each said outboard face of each notch allows for a ratcheting effect when used; and
said decreasing angle of each said outboard face of each notch is between 20 and 30 degrees.

8. The speed wrench of claim 7, wherein:
said decreasing angle of each said outboard face of each notch is approximately 25 degrees.

9. The speed wrench of claim 8, wherein:
each said notch has two outer tips; and
an imaginary line through said outer tips of each said notch will be at an angle less than 60 degrees with said engagement face of said in-line prong.

10. The speed wrench of claim 9, wherein:
said angle between said imaginary line through said outer lips of each said notch and said engagement face of said in-line prong is between 30 and 40 degrees.

11. The speed wrench of claim 10, wherein:
said angle between said imaginary line through said outer lips of each said notch and said engagement face of said in-line prong is a 34-degree angle.

12. A one-piece speed wrench for engaging and rotating a hexagonal fastener with outward sides of specified lengths and that are at specified angles to each other, comprising:
a handle and two engagement prongs joined at an engagement area;
one of said engagement prongs, an offset angle prong, contains at least one notch, a first notch;
said offset angle prong notch having two faces;
one of said faces of said first notch, an inboard face closest to said engagement area between said two prongs, is at an angle with an engagement face of said second prong when viewed from a side;
said angle between said inboard face of said first notch and said engagement face of said second prong approximately corresponds to or is slightly less than the specified angles between two outward sides of the hexagonal fastener;
said inboard face of said first notch having a shorter length than the specified lengths of the outward sides of the hexagonal fastener;
said first notch has an outboard face adjacent to said inboard face; and
said outboard face being at a decreasing angle with the second prong face in a direction away from said prong engagement area.

13. The speed wrench of claim 12, wherein:
said angle between said inboard face of said first notch and said engagement face of said second prong approximately corresponds to or is slightly less than a 60degree angle.

14. The speed wrench of claim 13, wherein:
said first notch has two outer tips; and
an imaginary line through said outer tips of said notch will be at an angle less than 60 degrees with said engagement face of said second prong.

15. The speed wrench of claim 14, wherein:
said decreasing angle of each said outboard face of each notch is between 20 and 30 degrees.
